(19) United States
(12) Patent Application Publication
(10) Pub. No.: US 2007/0100788 A1
(43) Pub. Date: May 3, 2007

(54) System design and manufacture

(75) Inventors: Chris Tofts, Bristol (GB); Richard Taylor, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 11/490,977

(22) Filed: Jul. 21, 2006

(30) Foreign Application Priority Data
Oct. 28, 2005 (GB) 0521987.8

(51) Int. Cl. G06F 17/30

(52) U.S. Cl. 707/1

(57) ABSTRACT

A method of system design and manufacture includes entering system details in a first user interface program 100. A transfer file 110 defining a spreadsheet including cells representing the system is created and transferred to a spreadsheet 120. The transfer file is arranged to define component count spreadsheet cells to permit user input to vary the numbers of at least some components of the system, and calculation cells to calculate the properties of the system for the component counts entered into the component count cells. The user can then adjust the spreadsheet to obtain a desired result, output the final configuration as output file 130 and pass the file to a manufacturing facility 140 to produce the designed system. The system designed and manufactured may be a computer system with many components.

The invention relates to a method and apparatus for system design and manufacture.

As technological complexity increases, the complexity of systems that must be delivered to customers in many fields of industry continues to increase. The increasing complexity of such systems means that it is increasingly difficult to design them economically by one individual using a sheet of paper, and this results in an increasing reliance on computers to assist in the design.

A particular case in point is complex computer systems that may be made up of many components such as disk drives, processors, input-output devices and many more. The number of such components can be large. The number of components is normally not known in advance. Instead, users require a system with particular processing power, input output and reliability requirements and require the cheapest design that will meet these targets.

The design of such systems involves many trade-offs. For example, redundancy can be built in to increase reliability. Alternatively, more reliable or better specified components can be used. It is very difficult to calculate the trade-off between these two possibilities of improving the reliability of the system.

It is not usually practical to design such systems by carrying out calculations using off-the shelf packages, such as spreadsheets. If each component requires a line of data in the spreadsheet, the number of lines of data that need to be checked as they are entered in the spreadsheet can be very large and this leads to mistakes being made and hence unsatisfactory results.

Instead, the inventors have previously developed proprietary software for inputting information regarding systems and calculating various figures of merit for them such as cost and reliability which has been used internally for designing and specifying computer systems for manufacture.

However, such proprietary systems have the disadvantage that it is difficult for untrained individuals such as customers to understand or appreciate the results, or understand how changing some requirements can lead to different results.

There is accordingly a need for a process that more readily delivers manufactured designs meeting system targets.

According to the invention there is provided <as claim 1>.

By entering the data in a first system the data can be readily entered in a proprietary system designed and adapted to this task, and in particular the data may be validated which is almost impossible when entering data and calculations directly into the spreadsheet. The system then compiles data into a spreadsheet to allow users to adjust some of the data and review the results without needing to understand the proprietary system.

The improvement in system design capabilities allows improved systems to be designed rapidly and in an intuitive way.

In a preferred embodiment, the spreadsheet is Microsoft EXCEL (RTM). The transfer file may be an XML file.

Note that the system does more than simply generate an EXCEL spreadsheet showing calculated results. The system populates some cells of the spreadsheet with calculations to create calculation cells to allow the user to change some parameters and calculate the results without needing to return to the first system to reenter data and recompile.

The authors are unaware of any other tools that do this. Conventional so-called EXCEL compilers take a spreadsheet entered on EXCEL and compile an executable file to produce the same results without the user needing to own a copy of EXCEL. The present system does the opposite - data is entered on a first system and then transferred to EXCEL to carry out calculations and display results.

For a better understanding of the invention embodiments will now be described, purely by way of example, with reference to the accompanying drawings, in which:

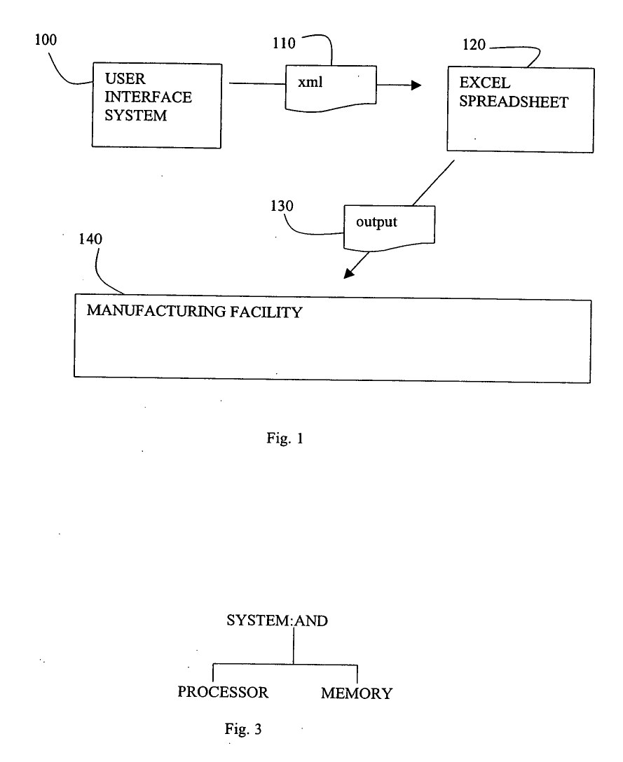

FIG. 1 illustrates a system according to an embodiment of the invention; and

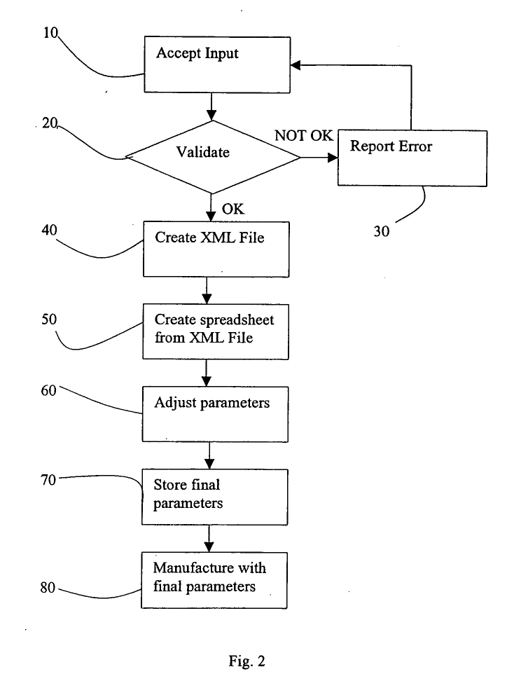

FIG. 2 illustrates a flow diagram of a method according to an embodiment of the invention; and

FIG. 3 is an illustration of a simple system designed and manufactured with the embodiment.

The first embodiment of the invention relates to a method of designing and manufacturing a computer system with a number of components.

A user interface system 100 is provided which accepts text input in the form of operators.

The operators define both the components of the system and the way they interreact.

A first operator is the component operator that defines a component of a computer system as a node:

component (name, [, ref name], mttf, mttr), where name is the name of the node, mttf is the mean time to failure, mttr is the mean time to recovery, and refname is an optional name used to refer to this node as will be explained below.

Thus, the component operators represent availability information which define the reliability of the components.

Such components are grouped in subsystems which are also represented by nodes. Various operators may be used depending on how each subsystem's reliability depends on the nodes.

If the subsystem requires all nodes within it to work, the operator is:

and (name, [, ref name], sc1 . . . scn) is used. Again, name is the name of the node. The and operator defines a list of n subcomponents sc1 . . . scn: all must work for the node to work.

Alternatively, a subsystem may be configured so that it works if any of its component nodes are working. In this case, the operator is:

or (name, [, ref name], sc1 . . . scn). Again, name is the name of the node. The or operator defines a list of n subcomponents sc1 . . . scn any one of which must work for the node to work.

Another operator is available in case some subcomponents are required. In this case, the operator is:

from (name, [, ref name], limit, sc1 . . . scn). Again, name is the name of the node. The from operator defines a list of n subcomponents sc1 . . . scn of which the number limit must work for the node to work.

In the case that one component can substitute for another after a certain time, a further oprator is available:

hotswap (name, [, ref name], swapTime, sc1 . . . scn). Again, name is the name of the node. The hotswap operator defines a list of n subcomponents sc1 . . . scn which can be substituted for one another after a time swapTime.

Two further operators allow multiple instances of a type of node:

ref (name, refName) means that the node of this operator, labelled name, is live (works) when the node refName is. Thus, ref is a cross reference operator.

To create copies, the operator:

copy (name, refName) means that the node is a copy of the node refName. This differs from ref since copy is another instance of the node copied. The node of the copy operator is not simply another reference to a node but another instance of a node which may be in operation or not independently of the node referred to.

To take a very simple example, a complete system, labelled “system” that only worked when a processor node and a memory node both worked could be coded:

and (system,

component (processor, 10000, 2),
component (memory, 5000,1)
)

The processor component has a mean time to failure of 10000 hours and takes 2 hours on average to replace and the memory component has a mean time to failure of 5000 hours and takes 1 hour to replace.

The system works only when both the processor and memory work. This system is illustrated schematically in FIG. 3, wherein the complete system is at the top of a tree and an “AND” operator connects the complete system to the processor and memory. As will be appreciated, real systems are a lot more complex than this.

In the first embodiment of the invention, the structure of the system to be designed is entered using these operators in text format. The operators “and”, “or”, “from”, and “hotswap” define the system structure as a set of system structure information. The “copy” and “ref” operators can define system structure details when used to refer to or copy “and”, “or”, “from” and “hotswap” nodes, and can also define component reliability details when used to refer to or copy component nodes.

The first step of the method is accordingly to enter (step 10) the user data into the user interface system 100 using these operators. The entered data conceptually forms a tree structure. The leaves of the tree are the components, which are grouped together in sub-systems and in turn make up the complete system.

Next, (step 20), the user interface system 100 validates the data and reports (step 30) any apparent anomalies that are detected to allow the user to return to step 10 to correct the data.

Once the data has been validated, the user interface system 100 creates an xml file 110 defining an Excel spreadsheet (step 40). The spreadsheet thus created will be described in more detail below.

Note that the spreadsheet created is a native Excel spreadsheet to obtain suitable processing speed, not a spreadsheet using VBA or other add-on system for carrying out calculations. The calculation cells are simply entered cells in the spreadsheet, in closed form.

The XML file 110 is then transferred to EXCEL spreadsheet 120 (step 50). This transfer process is performed by an inherent capability within the EXCEL program, it being capable of opening an XML file and displaying it in spreadsheet form without intervention on the part of a user. Once expressed visually as a spreadsheet—a form more readily assimilable by those who may be required to evaluate a model of a system (as contrasted with those who can create the model), a user can easily adjust the parameters to obtain, via the calculations performed by EXCEL suitable availability and reliability (step 60) values.

When the user is happy, the final parameters of the input cells are then stored in output file 130 (step 70).

This is passed to a manufacturing facility 140 where a system according to the details in output file 130 is created (step 80).

In this way a system can be manufactured and designed.

The power of this method can be seen by studying a simple example. A simple system can be specified as follows:

computer=component(10000,1)

network=component(20000,1)

compSys=and(computer,computer)

netSys=or(network,network)

Sys=and (compSys, netSys)

The expression of a system, defined above in a relatively natural syntax, in XML syntax results in an XML file which is illustrated in Appendix 1 hereto, from which it can be seen that even the specification of simple systems result in significant level of complexity when expressed in certain forms; in the present case XML, since this is a form which is directly assimilable by EXCEL.

The process by which a system as expressed in the above notation is converted into an XML file is described comprehensively in Appendix 2, and for the sake of brevity and clarity of concept will not be addressed further in the main body of this specification.

The compilation also creates two additional rows in the Excel spreadsheet for calculating the cost of the system. One row is used for calculating the fixed cost and one the running cost. The rows simply sum the fixed and running costs of each component.

The inventors have validated the results obtained for randomly generated systems and have found that the results are excellent, identical results to those calculated by other approaches being found rapidly and efficiently using the spreadsheet.

The approach is highly suitable for the simulation of rare events.

In a second embodiment of the invention, the text entry user interface of the first embodiment is replaced by a graphical user interface 100 which allows the user to design and view a system using a network diagram creating components and entering data without the need to enter the operators, though this remains possible. The second embodiment assists user input.

In a third embodiment, a further refinement is used during the process. Instead of simply recreating the structure of the system input into the original user interface system 100 in the spreadsheet, the compiler process automatically introduces some variability defined by parameters so that the user can adjust the parameters to adjust the structure.

Thus, the EXCEL spreadsheet is in fact more complex than the entered model since the spreadsheet includes input cells to change certain parameters.

In particular, and, or, from and hotswap operators define the relationships between a number of sub-units. In the third embodiment, the compiling process automatically allows a variation in the number of units.

For example, an “or” operator requiring one of three components to work can be entered as or (cluster1, processor1, processor2, processor3). Instead of simply providing a single row for each processor in the spreadsheet, the spreadsheet can be configured to automatically vary the number of processors. A data input cell accepting an integer number of processors is provided, populated initially with the number of processors (three) as in the original design. However, the user can change the data in the data input cell to change the number of processors in an attempt to improve the design.

In a “from” operation, two data input cells may be provided, one for adjusting the number of components which need to work simultaneously for the “from” node to work, and one for adjusting the number of sub-components.

Similar processing can be carried out for a hotswap node.

This allows users with only an understanding of the spreadsheet to adjust model parameters to view the result.

A further embodiment carries out more processing in user interface system 100, so this system can deliver information and allow design choices to be made before providing the output on the excel spreadsheet. In particular, calculations can be carried out in the user interface system 100 to calculate reliability, cost, and system throughput. Changes can then be made to the input data and the calculations repeated to allow the effects of different design choices to be determined. In this embodiment, an Excel spreadsheet is created after a suitable design choice is determined from the various calculations.

A problem that occurs is that carrying out calculations for large systems can be slow. In the case of large numbers of components, complex combinatorial calculations are required that can reduce the speed of the user interface system to such an extent that interactive real time use becomes impossible.

The embodiment addresses this issue using a specific computation technique.

Consider the case of an AND operation on eight components s1,s2,s3,s4,s5,s6,s7 and s8 which may be represented as AND(s1,s2,s3,s4,s5,s6,s7,s8).

This is calculated by replacing the AND operator where there are more than three operands with multiple AND operators. The multiple operands are divided into two groups, each group is ANDed and the results of each group are then ANDed. The process is repeated on the resulting groups which may still include AND statements with more than three operands until no further division is possible.

In the example, AND(s1,s2,s3,s4,s5,s6,s7,s8) becomes

AND(AND(s1,s2,s3,s4),AND(s5,s6,s7,s8)) which becomes in turn:

AND(AND(AND(s1,s2),AND(s3,s4)),AND(AND(s5,s6),AND(s7,s8)).

Thus a single eight operand AND is replaced with seven two-operand AND statements.

The same technique is used with OR operators with more than three operands.

In an example, OR(s1,s2,s3,s4,s5,s6,s7,s8) becomes

OR(OR(s1,s2,s3,s4),OR(s5,s6,s7,s8)) which becomes in turn:

OR(OR(OR(s1,s2),OR(s3,s4)),OR(OR(s5,s6),OR(s7,s8)).

Exactly the same benefits are obtained.

Further improvement in calculation speed is possible where the operands represent instances of like components. If s1,s2,s3,s4,s5,s6,s7,s8 represent identical components in an identical situation, for example eight memory units connected in parallel, then OR(s1,s2) is the same as OR(s3,s4) etc. Accordingly, the results for each OR operator with like operands are only calculated once to still further improve processing.

A modification to this approach is required for FROM operators.

Consider a requirement for 2n components from 2k components, where n and k are both integers. This may be represented as FROM(2n, s1, s2 . . . s2k).

An approximation to this is available in the case that n is much less than k.

In this case FROM(2n, s1, s2 . . . s2k)˜AND(FROM(n,s1 . . . sk), FROM(n,s(k+1) . . . s2k).

By using these expansions in the calculation engine of user interface 100 much faster processing is available.

This embodiment uses expansions in the user interface before passing the data to EXCEL for further or additional processing.

Other features can be added to any of the embodiments. For example, an abstract tree sheet can be provided to give the detail of the main sheet but only up to a certain level, to provide a summary.

A further sheet, or rows, can be used to count components and outage to allow calculation of the spares and maintenance costs of the system.

1. A method of creating a complete system, comprising:
entering system details regarding the components of the system and their inter-relation and at least one system figure of merit;
compiling a transfer file defining a spreadsheet including cells representing the components, the cells including calculation cells calculating the at least one figure of merit of the system from the system details;
running the transfer file in the spreadsheet environment to create a spreadsheet calculating the at least one system figure of merit;
waiting for data entry to allow the user to change the system details in the spreadsheet environment and to recalculate the at least one figure of merit;
waiting for data entry to indicate that the system is finalised and creating a final system structure based on the system details.

2. A method according to claim 1 of designing and manufacturing a complete system made up of a plurality of components of a plurality of component types to have a required reliability, wherein entering system details includes entering component reliability details regarding the reliability of each of the plurality of component types in a first data entry system; and entering system structure details specifying how the system is made up of components of the component types in the first data entry system.

3. A method according to claim 1 further comprising manufacturing a complete system according to the final system structure.

4. A method according to claim 1 wherein the spreadsheet is an Excel spreadsheet.

5. A method according to claim 1 wherein the file structure is an xml file structure.

6. A method according to claim 1, wherein, when the system details define a specific plural number of like components, the step of compiling the spreadsheet includes creating a component count cell initially populated with that specific plural number, and creating a number of instances the like components in the spreadsheet based on the number in the count cell, so that a spreadsheet user may vary the number of components being modelled by varying the number in the component count cell.

7. A method according to claim 6, wherein when the system requires a specific plural number of like components to be working from a list of components, the step of compiling the spreadsheet includes creating a required count cell initially populated with the specific plural number of like components, so that a spreadsheet user may vary the required number of components being modelled by varying the number in the required count cell.

8. A computer program product for creating a complete system in cooperation with a spreadsheet program, comprising:
code for entering system details regarding the components of the system and their inter-relation and at least one system figure of merit; and
code for compiling a transfer file defining a spreadsheet including cells representing the components, the cells including calculation cells calculating the at least one figure of merit of the system from the system details so that the transfer file can be run in the spreadsheet environment to create a spreadsheet calculating the at least one system figure of merit for the system details.

9. A computer program product according to claim 8 wherein the spreadsheet is an Excel spreadsheet program and the transfer file is arranged to define an Excel spreadsheet.

10. A computer program product according to claim 8 wherein the code for compiling a transfer file is arranged, when the system details define a specific plural number of like components, to compile the spreadsheet to include a component count cell initially populated with that specific plural number, and to create a number of instances of the like components in the spreadsheet based on the number in the count cell, so that a spreadsheet user may vary the number of components being modelled by varying the number in the component count cell.

11. A computer program product according to claim 8, wherein the code for creating the transfer file is arranged:
to create target availability and availability cells for various components and sub-systems in the spreadsheet,
to define the spreadsheet to calculate target availability for components by evenly dividing up the availability requirement of the complete system; and
to define the spreadsheet to calculate availability for components from the system details.

12. A computer program product according to claim 11 wherein the code for creating the transfer file is arranged to define the spreadsheet to highlight cells for which the target availability is greater than the availability.

13. Apparatus for designing a system, comprising:
a user interface arranged to receive from a user to enter system details regarding the components of the system and their inter-relation and at least one system figure of merit;
a processor arranged to compile a transfer file defining a spreadsheet including cells representing the components, the cells including calculation cells calculating the at least one figure of merit of the system from the system details; and
a spreadsheet program arranged to run the transfer file in the spreadsheet environment to create a spreadsheet calculating the at least one system figure of merit;
to wait for data entry to allow the user to change the system details in the spreadsheet environment and to recalculate the at least one figure of merit, and to save final system details.

14. Apparatus according to claim 13 wherein the spreadsheet program is Excel.

15. Apparatus according to claim 13 wherein the processor is arranged, when the system details define a specific plural number of like components, to compile the spreadsheet to include a component count cell initially populated with that specific plural number, and to create a number of instances of the like components in the spreadsheet based on the number in the count cell, so that a spreadsheet user may vary the number of components being modelled by varying the number in the component count cell.

16. A method comprising:
entering system details regarding a system having components in a first user interface program;
compiling a transfer file defining a spreadsheet including cells representing the system and running the transfer file in an Excel spreadsheet environment to create a spreadsheet;
wherein the transfer file is arranged to define component count spreadsheet cells to permit user input to vary the numbers of at least some components of the system, and calculation cells to calculate the properties of the system for the component counts entered into the component count cells.

17. A method according to claim 16, further comprising including in the spreadsheet at least one required count cell initially populated with a specific plural number of like components required for operation, so that a spreadsheet user may vary the required number of components by varying the number in the required count cell.

18. A method according to claim 16 further comprising:
waiting for data entry to allow the user to change the system details in the spreadsheet environment; and
waiting for data entry to indicate that the system is finalised and creating a final system structure based on the system details as amended at that time.
